(19) United States
(12) Patent Application Publication
(10) Pub. No.: US 2015/0212884 A1
(43) Pub. Date: Jul. 30, 2015

(54) MEMORY CONTROLLER, STORAGE DEVICE, AND MEMORY CONTROL METHOD

(71) Applicant: Kabushiki Kaisha Toshiba, Minato-ku (JP)

(72) Inventors: Yu NAKANISHI, Yokohama (JP); Daisuke IWAI, Yokohama (JP); Hiroshi YAO, Yokohama (JP); Naomi TAKEDA, Yokohama (JP); Arata MIYAMOTO, Kita (JP); Daiki WATANABE, Yokohama (JP)

(73) Assignee: Kabushiki Kaisha Toshiba, Minato-ku (JP)

(21) Appl. No.: 14/474,831

(22) Filed: Sep. 2, 2014

Related U.S. Application Data
(60) Provisional application No. 61/932,019, filed on Jan. 27, 2014.

(51) Int. Cl. G06F 11/10

(52) U.S. Cl. CPC G06F 11/1072; G06F 11/1044; G06F 11/108

(57) ABSTRACT

According to one embodiment, a storage device includes an encoder, a nonvolatile memory that stores user data and a parity, a magnetic disk, and a management unit that holds correspondence between a logical address and a first physical address as first conversion information, and holds correspondence between the first physical address and a second physical address as second conversion information, with the second physical address including media information indicating a medium of a storage destination and information indicating a storage position. When the user data stored in the nonvolatile memory is to be moved to the magnetic disk, the management unit updates the second physical address of the user date in the second conversion information, to a value indicating a storage destination after the movement.

### CROSS-REFERENCE TO RELATED APPLICATIONS

This application is based upon and claims the benefit of priority from U.S. Provisional Application No. 61/932,019, filed on Jan. 27, 2014; the entire contents of which are incorporated herein by reference.

### FIELD

Embodiments described herein relate generally to a memory controller, a storage device, and a memory control method.

### BACKGROUND

In a NAND flash memory, data access is performed at a high speed although the cost per unit capacity is high. In a hard disk (a magnetic disk), data access is performed at a low speed although the cost per unit capacity is low. In recent years, a hybrid storage device has been developed, which includes both a NAND flash memory and a hard disk, so that data requiring high-speed access is stored in the NAND flash memory and data not requiring high-speed access is stored in the hard disk. Meanwhile, in the NAND flash memory, it is general to add a parity for error correction to data to be stored, in order to maintain reliability. In order to enable correction of a burst error in which data is lost at once, such as block loss in which the entire block, which is a unit of erasure of the NAND flash memory, cannot be read, a code word needs to be constituted by data stored in a plurality of areas on the NAND flash memory. For example, in order to enable correction of data at the time of the block loss, the code word needs to be constituted by data stored in a plurality of blocks.

### BRIEF DESCRIPTION OF THE DRAWINGS

FIG. 1 is a block diagram of a configuration example of a storage device according to a first embodiment;

FIG. 2 is an example of an address management table according to the first embodiment;

FIG. 3 is an example of a writing procedure in the storage device according to the first embodiment;

FIG. 4 is an example of contents of the address management table before copying to a magnetic disk is performed;

FIG. 5 is an example of contents of the address management table after copying to the magnetic disk is performed;

FIG. 6 is an example of a parity generated by an encoding unit of a NAND control unit according to the first embodiment;

FIG. 7 is an example of a reading procedure in the storage device according to the first embodiment, when only an in-page parity is used;

FIG. 8 is an example of the address management table when a code word is constituted by a plurality of chips of a NAND memory;

FIG. 9 is an example of the address management table when the code word is constituted by a plurality of chips of the NAND memory;

FIG. 10 is an example of an encoding process procedure when an inter-page parity is used;

FIG. 11 is an example in which a physical address of a write destination of the parity is included in a media table;

FIG. 12 is an example of the reading procedure when the inter-page parity is used;

FIG. 13 is an example of a configuration of a code word according to a second embodiment;

FIG. 14 is an example of a configuration of the code word according to the second embodiment; and

FIG. 15 is an example of a reading procedure when user data is protected by a plurality of inter-page parities.

### DETAILED DESCRIPTION

In general, according to one embodiment, a storage device includes an encoder, a nonvolatile memory that stores user data and a parity, a magnetic disk, and a management unit that holds correspondence between a logical address and a first physical address as first conversion information, and holds correspondence between the first physical address and a second physical address as second conversion information, with the second physical address including media information indicating a medium of a storage destination and information indicating a storage position. When the user data stored in the nonvolatile memory is to be moved to the magnetic disk, the management unit updates the second physical address of the user date in the second conversion information, to a value indicating a storage destination after the movement.

Exemplary embodiments of a storage device, and a memory control method will be explained below in detail with reference to the accompanying drawings. The present invention is not limited to the following embodiments.

### First Embodiment

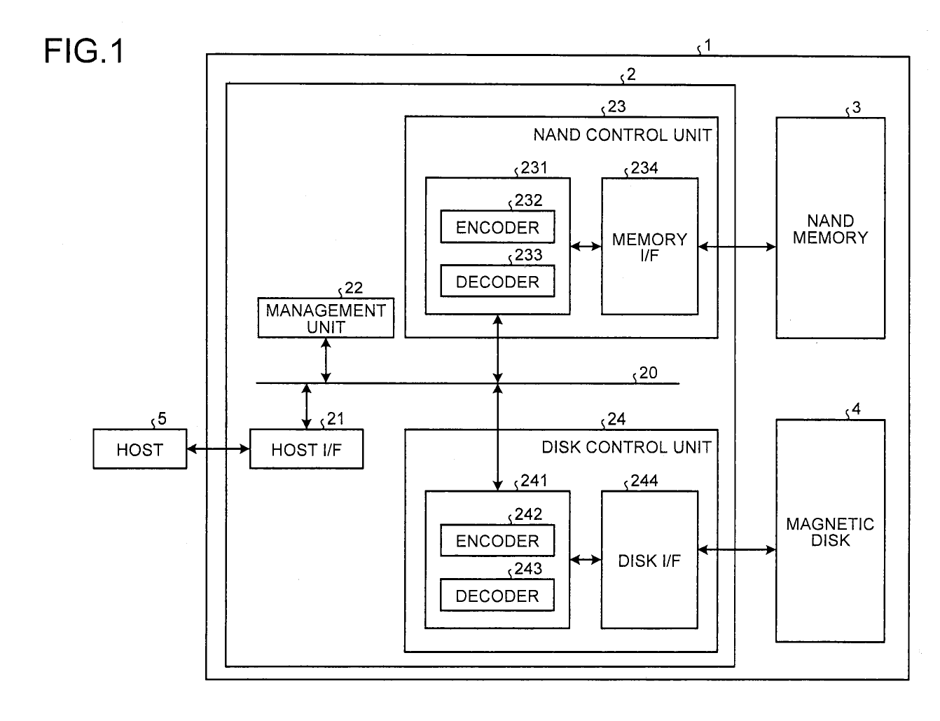

FIG. 1 is a block diagram of a configuration example of a storage device 1 according to a first embodiment. The storage device 1 according to the present embodiment includes a memory controller 2, a NAND memory (a nonvolatile memory) 3, and a magnetic disk 4. The storage device 1 can be connected to a host 5, and a state of the storage device 1 connected to the host 5 is shown in FIG. 1. The host 5 can be, for example, a personal computer, an electronic device such as a mobile terminal, or an external interface.

The storage device 1 according to the present embodiment is a hybrid drive having the NAND memory 3 and the magnetic disk 4. In the hybrid drive, the NAND memory 3 is used as, for example, a write cache. That is, data from the host 5 is once written in the NAND memory 3 used as a cache memory. The data from the host 5 is then written in the magnetic disk 4.

The NAND memory 3 is a nonvolatile memory that stores data in a nonvolatile manner. Writing is performed to the NAND memory 3 in a unit of writing referred to as “page”. In the NAND memory 3, data is erased in a unit of data referred to as “block”. One block includes a plurality of pages. Furthermore, the NAND memory 3 can be constituted of a plurality of chips (memory chips). The chip includes one or more blocks.

The memory controller 2 includes a host I/F (Interface) 21, a management unit 22, a NAND control unit 23, and a disk control unit 24. The NAND control unit 23 controls the NAND memory 3 based on an instruction from the management unit 22. The NAND control unit 23 includes an encoding/decoding unit 231 and a memory I/F 234. The encoding/decoding unit 231 includes an encoder 232 and a decoder 233. The disk control unit 24 controls the magnetic disk 4 based on an instruction from the management unit 22. The disk control unit 24 includes an encoding/decoding unit 241 and a disk I/F 244. The encoding/decoding unit 241 includes an encoder 242 and a decoder 243.

The host I/F 21 outputs a command and user data (write data) and the like received from the host 5 to an internal bus 20. Furthermore, the host I/F 21 transmits user data read from the NAND memory 3 and the magnetic disk 4, a response from the management unit 22, and the like to the host 5.

The management unit 22 is a CPU (Central Processing Unit), an MPU (Micro Processing Unit), or the like and controls respective constituent elements of the storage device 1 in an integrated manner. The management unit 22 controls writing and reading operations according to a request from the host 5 received via the host I/F 21, and outputs a response to the host 5 to the host I/F 21. For example, the management unit 22 controls writing to the magnetic disk 4 and reading from the magnetic disk 4 via the disk control unit 24. Further, the management unit 22 controls writing to the NAND memory 3 and reading from the NAND memory 3 via the NAND control unit 23.

The user data received from the host 5 is input to the NAND control unit 23 via the internal bus 20. At this time, the controller 2 can store the user data received from the host 5 once in a data buffer (not shown), and then input the user data read from the data buffer to the NAND control unit 23. The management unit 22 determines a memory area of a storage destination of the user data with respect to data (page data) in a unit of page, which is a unit of writing. In the present specification, the user data stored in one page of the NAND memory 3 is defined as unit data. When encoding is performed for each page data and parity is added, the size of page data becomes a size obtained by adding the size of the unit data and the size of the parity. When encoding for each page data is not performed, the size of page data can be the same as the size of unit data.

In the present specification, a memory cell connected commonly to one word line is defined as a memory cell group. When the memory cell is a single-level cell, the memory cell group corresponds to one page. When the memory cell is a multi-level cell, the memory cell group corresponds to a plurality of pages. For example, when a multi-level cell capable of storing two bits is used, the memory cell group corresponds to two pages. A physical address is allocated to a memory area of the nonvolatile memory 3. The management unit 22 manages the memory area of a write destination of the unit data by using the physical address. The management unit 22 specifies the determined memory area (the physical address) and instructs the NAND control unit 23 to write the user data in the NAND memory 3. The management unit 22 manages correspondence between a logical address (a logical address managed by the host 5) and the physical address of the user data. In the present embodiment, correspondence between the logical address and the physical address on the NAND memory 3 is managed by using two tables described later.

Furthermore, in the storage device 1 according to the present embodiment, the NAND memory 3 is used as a cache, and when a certain condition is satisfied, the user data stored in the NAND memory 3 is copied to the magnetic disk 4 and erased from the NAND memory 3. When a parity is added to the user data, the parity is also copied to the magnetic disk 4 and is erased from the NAND memory 3. When having determined to copy the user data (or the user data and parity) from the NAND memory 3 to the magnetic disk 4, the management unit 22 determines a storage area on the magnetic disk 4, specifies a physical address indicating the storage area (a physical address on the magnetic disk 4), and instructs the disk control unit 24 to write the user data in the magnetic disk 4. The management unit 22 manages the correspondence between the logical address of the user data (the logical address managed by the host 5) and the physical address on the magnetic disk 4 by using two tables described later.

Upon reception of a read command including the logical address from the host 5, the management unit 22 identifies a storage medium (the NAND memory 3 or the magnetic disk 4) corresponding to the logical address and the physical address, specifies the physical address, and instructs reading of the user data to the NAND memory 3 or the magnetic disk 4.

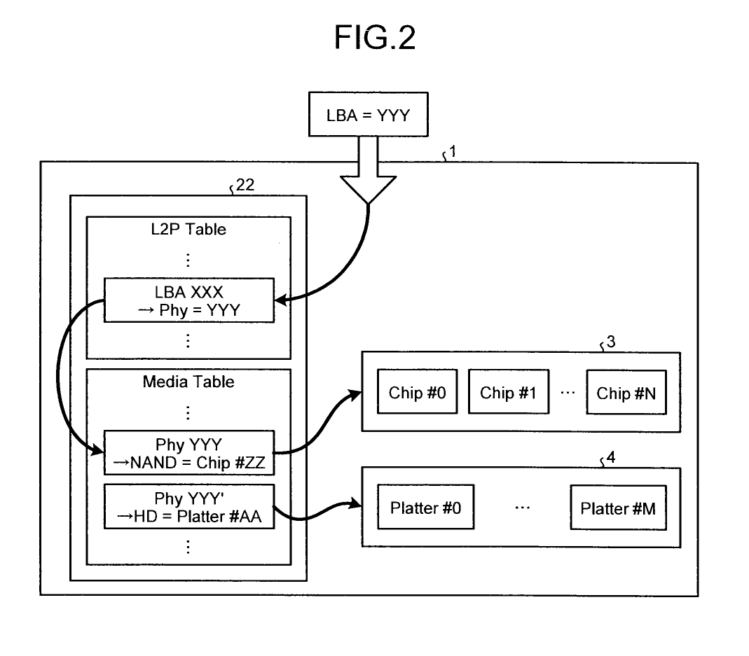

FIG. 2 is an example of an address management table according to the present embodiment. In the present embodiment, the address management table is constituted by two tables of an L2P table (first conversion information) and a media table (second conversion information). In the L2P table, correspondence information between a logical address (LBA) and a first physical address is stored. In the media table, correspondence information between the first physical address and a second physical address is stored.

The first physical address does not indicate an actual physical address on the NAND memory 3 or the magnetic disk 4, but indicates an intermediate physical address for identifying an actual physical address on the NAND memory 3 or the magnetic disk 4. The first physical address does not include information for discriminating a medium (the NAND memory 3 or the magnetic disk 4) as a storage destination of data. The first physical address is an intermediate physical address to be used in the controller 2 as described above, and can be determined by an arbitrary method. The second physical address includes information for discriminating the medium (the NAND memory 3 or the magnetic disk 4) as the storage destination of data and a physical address on the medium.

In FIG. 2, an example in which the NAND memory 3 includes N+1 chips from a chip #0 to a chip #N, and the magnetic disk 4 includes M+1 platters from a platter #0 to a platter #M is shown. For example, it is assumed that upon reception of a write request from the host 5, the management unit 22 determines “YYY” as the first physical address corresponding to user data to be written with a logical address “XXX”. In this case, the management unit 22 stores “YYY” in the L2P table as the first physical address (in FIG. 2, abbreviated as “Phy”) corresponding to the logical address “XXX” as shown in FIG. 2. The management unit 22 determines a write destination medium in which the user data with the logical address “XXX” is to be written, and a physical address on the medium. For example, it is assumed that the management unit 22 determines a chip #ZZ on the NAND memory 3 as a write destination of the user data corresponding to the logical address “XXX”. In this case, as shown in FIG. 2, the management unit 22 stores information indicating that the storage medium is the NAND memory 3 (in FIG. 2, abbreviated as “NAND”) and the physical address on the NAND memory 3 (the chip #ZZ), as the second physical address corresponding to the first physical address “YYY”. Although the physical address on the NAND memory 3 is described here for only the chip for the sake of simplification, actually, an address in a unit corresponding to the user data length indicated by the logical address in the L2P table is stored. For example, in the L2P table, when correspondence between the logical address and the first physical address is managed for each of user data corresponding to one page on the NAND memory 3, the second physical address includes an address indicating a page in which the user data is written as the physical address on the NAND memory 3.

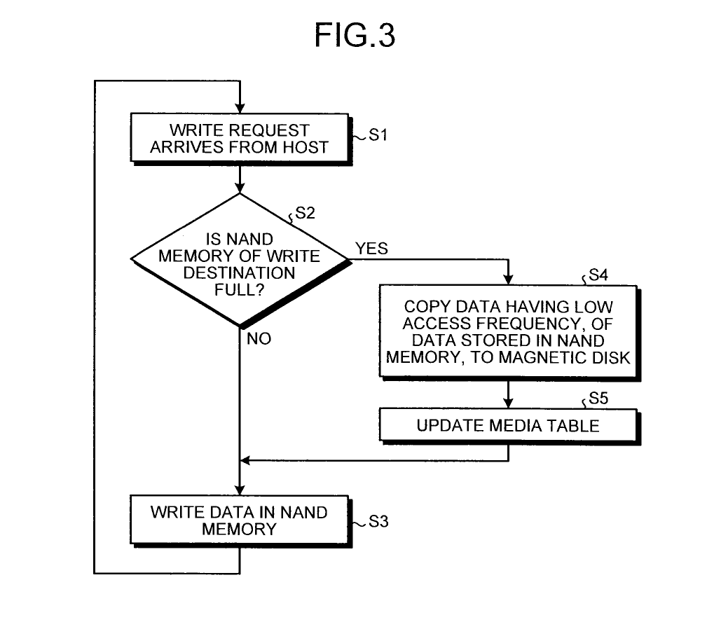

FIG. 3 is an example of a writing procedure in the storage device 1 according to the present embodiment. A write request arrives from the host 5 (Step S1). The management unit 22 determines whether the NAND memory 3 is full (does not have a free space) (Step S2). When the NAND memory 3 is not full (No at Step S2), the management unit 22 determines a physical address on the NAND memory 3 of the write destination of the user data, and updates the media table based on a determination result. The management unit 22 then instructs the NAND control unit 23 to write the user data based on the media table. The NAND control unit 23 writes the user data in the NAND memory 3 based on the instruction (Step S3). At the time of writing, when a parity is to be added, the encoder 232 performs encoding to generate a parity, and the NAND control unit 23 also writes the parity in the NAND memory 3.

When the NAND memory 3 is full (Yes at Step S2), the management unit 22 copies data having a low access frequency, of the data (the user data and parity) stored in the NAND memory 3, to the magnetic disk 4 (Step S4). Data having a low access frequency is copied here to the magnetic disk 4. However, data to be copied can be determined, for example, by using a reference other than the access frequency, such as the order of the stored time (an order of storage).

At Step S4, specifically, the management unit 22 instructs the NAND control unit 23 to read data from the NAND memory 3, and to erase data at the physical address after reading of data. Furthermore, the management unit 22 determines a physical address on the magnetic disk 4 of the write destination of data read from the NAND memory 3. The management unit 22 instructs the disk control unit 24 to write the data read from the NAND memory 3 to the determined physical address on the magnetic disk 4. The NAND control unit 23 reads data stored at the instructed physical address based on the instruction from the management unit 22, outputs the data to the internal bus 20, and erases the memory area after the reading. The disk control unit 24 stores the data input from the internal bus 20 in an area on the magnetic disk 4 indicated by the physical address instructed from the management unit 22. At this time, when data to be written in the magnetic disk 4 is to be encoded and written, a code word after being encoded by the encoder 242 is written in the magnetic disk 4. After completion of copying at Step S4, the management unit 22 updates the second physical address corresponding to the first physical address of the source data in the media table to the second physical address corresponding to the copy destination (Step S5), and the process proceeds to Step S3.

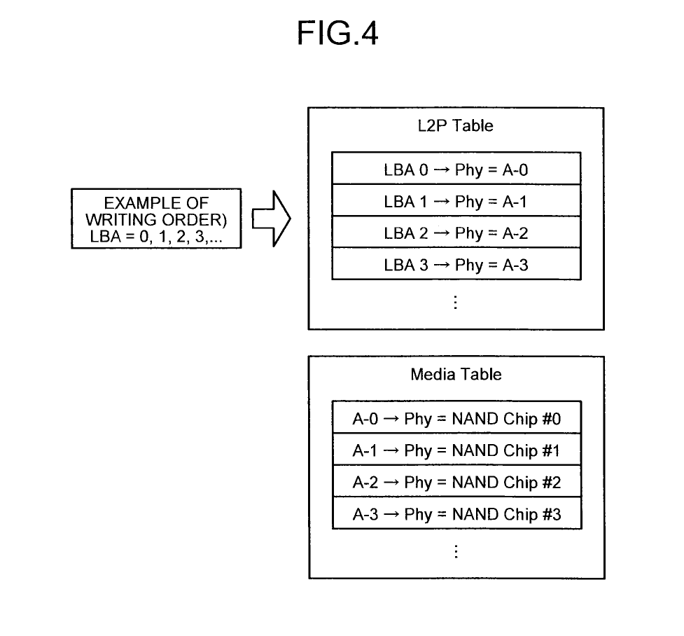

As described above, in the present embodiment, all the pieces of user data requested to be written from the host 5 are initially stored in the NAND memory 3. FIG. 4 is an example of contents of the address management table before copying to the magnetic disk 4 is performed. In FIG. 4, an example in which writing is requested in an order of LBA “0”, “1”, “2”, . . . is shown as an example of a writing order (an order requested to be written). As shown in FIG. 4, in the media table, all the second physical addresses corresponding to the first physical addresses “A-0”, “A-1”, “A-2”, “A-3”, . . . indicate physical addresses on the NAND memory 3.

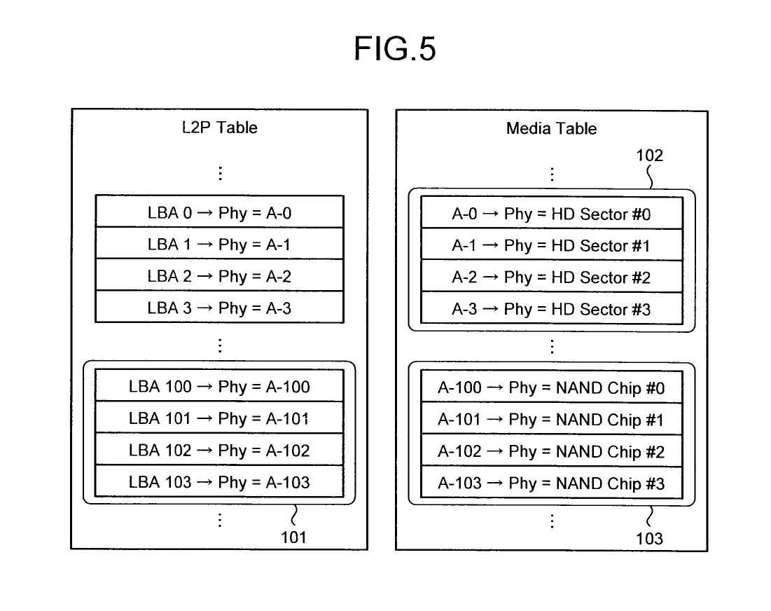

FIG. 5 is an example of contents of the address management table after copying to the magnetic disk 4 is performed. The example in FIG. 5 shows a state after pieces of data corresponding to logical addresses “0”, “1”, “2”, and “3” are copied to the magnetic disk 4 from the state shown in FIG. 4, because there is no free space in the NAND memory 3, when pieces of user data having logical addresses “100”, “101”, . . . are received from the host 5. An entry 101 corresponding to new user data in the L2P table corresponds to an entry 103 in the media table. In the entry 103, the second physical address indicates a physical address on the NAND memory 3. In an entry 102 in the media table corresponding to the data copied to the magnetic disk 4, the second physical address is changed to the physical address on the magnetic disk 4. In this manner, when the data is copied to the magnetic disk 4, the first physical address in the L2P table is not changed, but the second physical address in the media table is changed.

An encoding process performed by the NAND control unit 23 according to the present embodiment is explained next. The encoder 232 generates a parity by the encoding process with respect to user data to be written in the NAND memory 3. The method of the encoding process is not particularly limited thereto. At this time, various modes can be considered for a combination of user data constituting the code word (user data+parity). For example, as a first example, there is a mode in which user data in the same page is encoded to generate a parity, and the parity is stored in the same page together with the user data. In the following descriptions, the parity generated in this manner is referred to as “in-page parity”. In the NAND memory 3, because writing and reading are performed in a unit of page, if the code word is constituted by user data and a parity in the same page, another page does not need to be read when decoding is performed at the time of reading, and a reading process can be performed at a high speed.

As a second example, there is a mode in which the user data to be stored in a plurality of pages is encoded to generate a parity. In the following descriptions, the parity generated in this manner is referred to as “inter-page parity”. In this case, when reading cannot be performed in a unit of page, data of the page that cannot be read can be restored. If the code word is constituted by user data stored in a plurality of blocks, when reading cannot be performed in a unit of block, data of the block that cannot be read can be restored. Furthermore, if the code word is constituted by user data stored in a plurality of chips, when reading cannot be performed in a unit of chip, data of the chip that cannot be read can be restored.

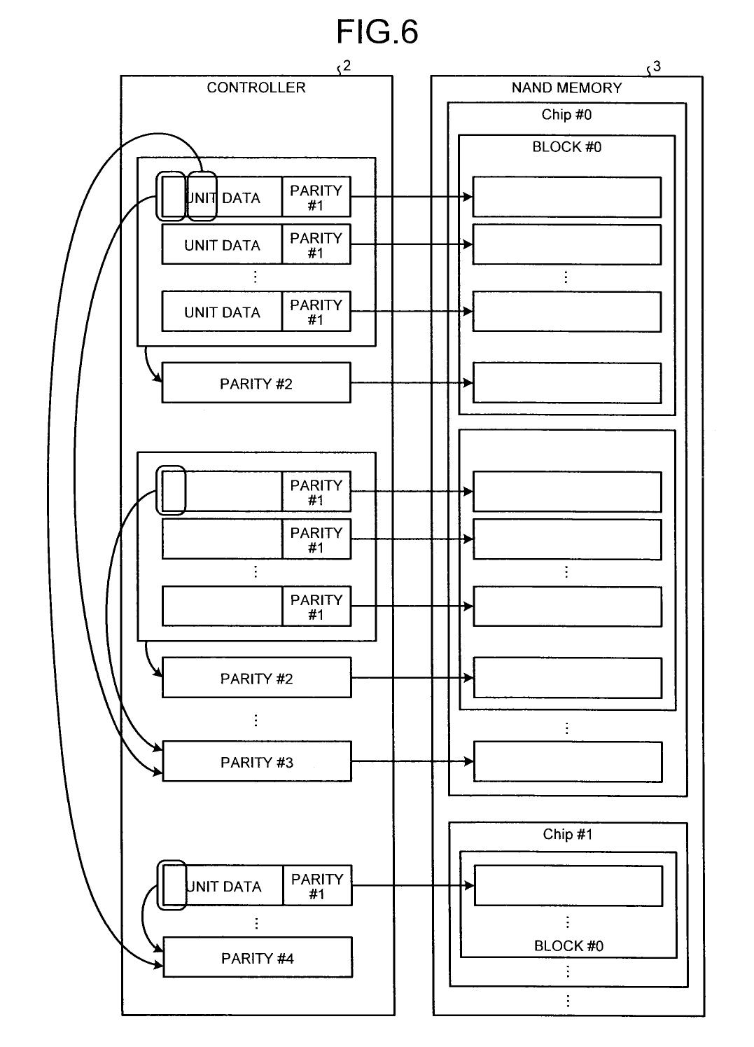

FIG. 6 is an example of a parity generated by the encoder 232 of the NAND control unit 23 according to the present embodiment. As described above, the user data to be stored in one page is designated as unit data, and the parity generated by using the unit data (the in-page parity) is designated as “parity #1”. In FIG. 6, the inter-page parity generated by using user data over a plurality of pages in the same block is designated as “parity #2”. Furthermore, the inter-page parity generated by using user data over a plurality of blocks in the same chip is designated as “parity #3”, and the inter-page parity generated by using user data over a plurality of chips is designated as “parity #4”. In FIG. 6, four types of parities are shown; however, all types of parities do not need to be generated, and one or more of the four types of parities needs only to be generated. The storage positions on the NAND memory 3 of the parity #2, the parity #3, and the parity #4 shown in FIG. 6 are an example only, and the storage positions on the NAND memory 3 of the parity #2, the parity #3, and the parity #4 are not limited to the example shown in FIG. 6. For example, a parity dedicated block or a parity dedicated chip for storing the parity #2, the parity #3, and the parity #4 can be provided. Further, the parity #2, the parity #3, and the parity #4 can be stored in the magnetic disk 4.

When only the in-page parity is used, reading from the NAND memory 3 is performed in a unit of page. Therefore, when data is copied to the magnetic disk 4, the entire code word is copied, and thus one code word is not stored in two media in a distributed manner.

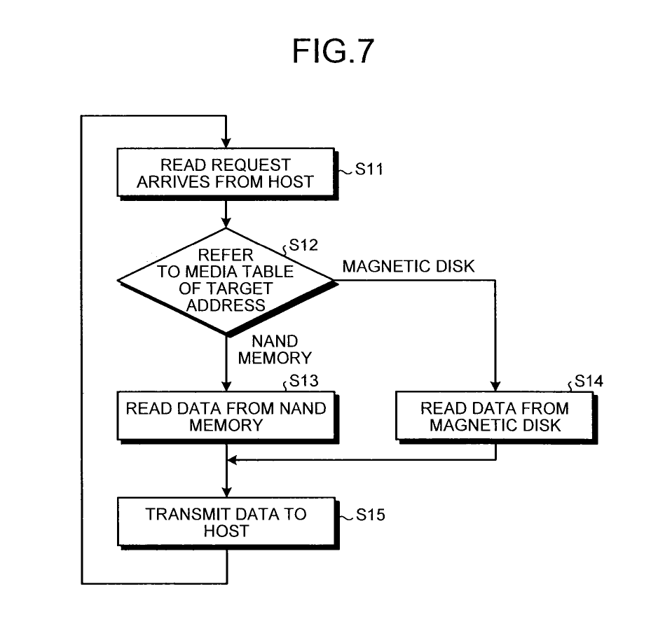

FIG. 7 is an example of the reading process in the storage device 1 according to the present embodiment, when only the in-page parity is used. When encoding is not performed at the time of writing of user data to the NAND memory 3 (no parity is added), reading is performed according to the procedure shown in FIG. 7. As shown in FIG. 7, a read request arrives from the host 5 (Step S11). The management unit 22 converts the logical address specified by the host 5 to the first physical address by using the L2P table, and determines whether a storage medium indicated by the second physical address corresponding to the first physical address is the NAND memory 3 or the magnetic disk 4, by referring to the media table (Step S12).

When the storage medium indicated by the second physical address is the NAND memory 3 (the NAND memory at Step S12), the management unit 22 instructs the NAND control unit 23 to read data corresponding to the second physical address from the NAND memory 3. The NAND control unit 23 reads data from the NAND memory 3 based on the instruction (Step S13). The data to be read at this time is user data when the parity is not added, or the user data and parity corresponding to the user data when the parity is added. When the parity is added, the decoder 233 performs an error correction process by using the user data and parity corresponding to the user data.

The management unit 22 transmits the user data read from the NAND memory 3 (when the parity is added, the user data after error correction) to the host 5 via the host I/F 21 (Step S15).

When the storage medium indicated by the second physical address is the magnetic disk 4 (the magnetic disk at Step S12), the management unit 22 instructs the disk control unit 24 to read data corresponding to the second physical address from the magnetic disk 4. The disk control unit 24 reads data from the magnetic disk 4 based on the instruction (Step S14) and the process proceeds to Step S15. The disk control unit 24 then transmits the read user data to the host 5. The data to be read at this time is user data copied from the NAND memory 3 (or the user data and parity) when encoding by the encoder 242 has not been performed at the time of writing. When encoding by the encoder 242 has been performed, the data to be read is a code word obtained by encoding the user data (or the user data and parity) copied from the NAND memory 3. When encoding by the encoder 242 has been performed at the time of write, the decoder 243 performs the error correction process by using the code word. When the parity has been added at the time of storage in the NAND memory 3, the decoder 233 of the NAND control unit 23 performs the error correction process by using the user data and parity read from the magnetic disk 4, and transmits the user data after the error correction process to the host 5.

In the NAND memory 3, erasure is performed in a unit of block. Therefore, it can be considered to designate a minimum unit of a copy to the magnetic disk 4 as one block. When the minimum unit of a copy is set to one block and the inter-page parity is to be generated within the same block, one code word is not stored in the magnetic disk 4 and the NAND memory 3 in a distributed manner. Accordingly, also in this case, the reading procedure shown in FIG. 7 can be used.

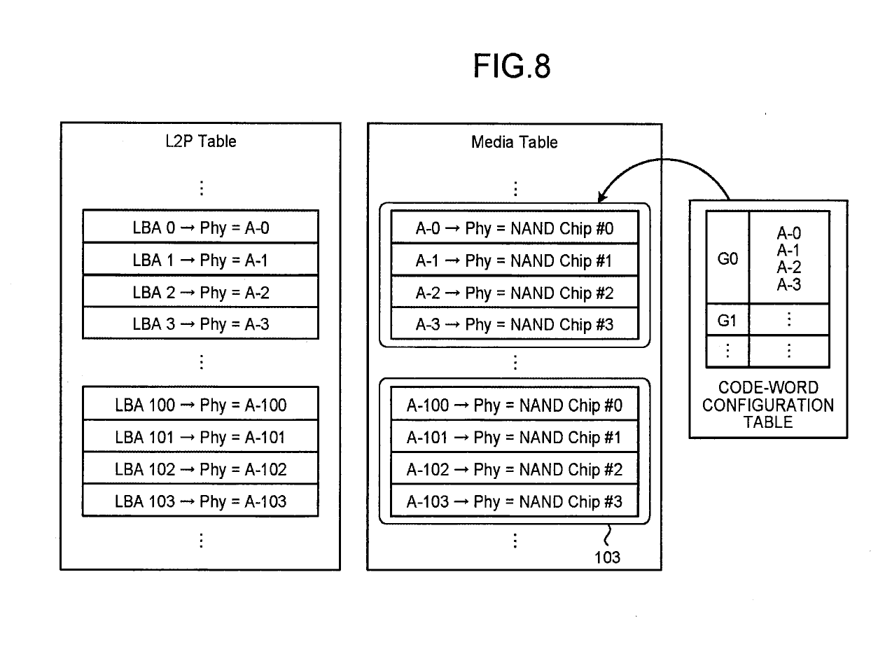

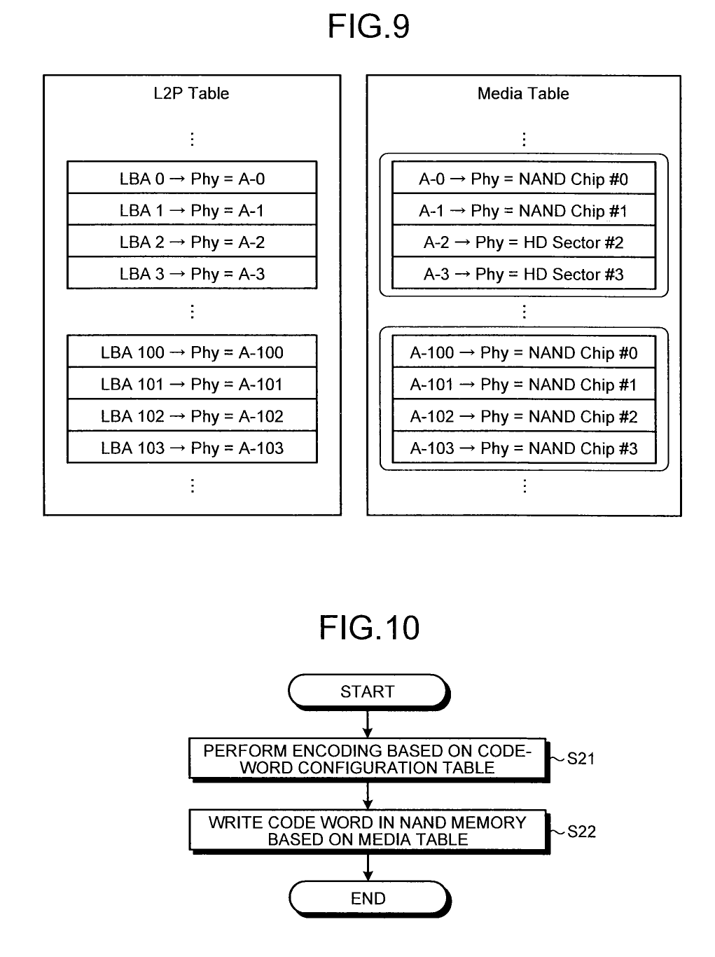

On the other hand, when the inter-page parity is to be used, there is a possibility that a part of one code word is copied to the magnetic disk 4. In this case, one code word is stored in the NAND memory 3 and the magnetic disk 4 in a distributed manner. FIGS. 8 and 9 are examples of the address management table when the code word is constituted by a plurality of chips of the NAND memory 3. FIG. 8 illustrates a state before copying to the magnetic disk 4 is performed, and FIG. 9 illustrates a state after pieces of user data having first physical addresses of “A-2” and “A-3” are copied to the magnetic disk 4. A code word group 103 encircled in FIG. 8 indicates a second physical address corresponding to the user data constituting one code word, respectively.

It is assumed that information indicating which user data constitutes the code word is managed, for example, by a code-word configuration table shown in FIG. 8. The management unit 22 determines beforehand a physical address on the NAND memory 3 constituting the code word corresponding to a memory configuration (a configuration of chips and blocks) of the NAND memory 3. The information related to the code word configuration (code-word configuration information) is held as the code-word configuration table. The management unit 22 instructs the NAND control unit 23 to encode data to be written in the NAND memory 3 and write the data in the NAND memory 3, based on the code-word configuration table. FIG. 8 is an example in which groups of user data constituting the code word are designated as G0, G1, . . . and pieces of user data belonging to respective groups are managed by using the first physical address. As a management method of the code-word configuration table, the memory address on the NAND memory 3 can be used or the logical address can be used, without using the first physical address. However, if management thereof is performed by using the first physical address, the configuration of the code word can be managed in a centralized manner, even when the user data is copied to the magnetic disk 4 as described below. It is assumed here that in the code-word configuration table, the group configuration is managed by using the first physical address.

FIG. 10 is an example of an encoding process procedure when the inter-page parity is used. The encoding process here illustrates the writing process at Step S3 in FIG. 3 in more detail. The management unit 22 specifies user data to be encoded based on the code-word configuration table and instructs the NAND control unit 23 to perform encoding. The encoder 232 performs encoding based on the instruction to generate a parity (Step S21). The management unit 22 determines a physical address on the NAND memory 3 of the user data to be encoded and updates the media table. The management unit 22 then gives an instruction of a physical address of a storage destination of the user data and the generated parity (the code word) to the NAND control unit 23. The NAND control unit 23 writes the code word in the NAND memory 3 based on the instruction (Step S22). A write destination of the parity can be determined by any method, and a management method of the physical address as the write destination of the parity can be any method. The physical address of the write destination of the parity can be included in the code-word configuration table, or a first physical address is allocated to the parity as described below, and the physical address of the write destination of the parity can be included in the media table.

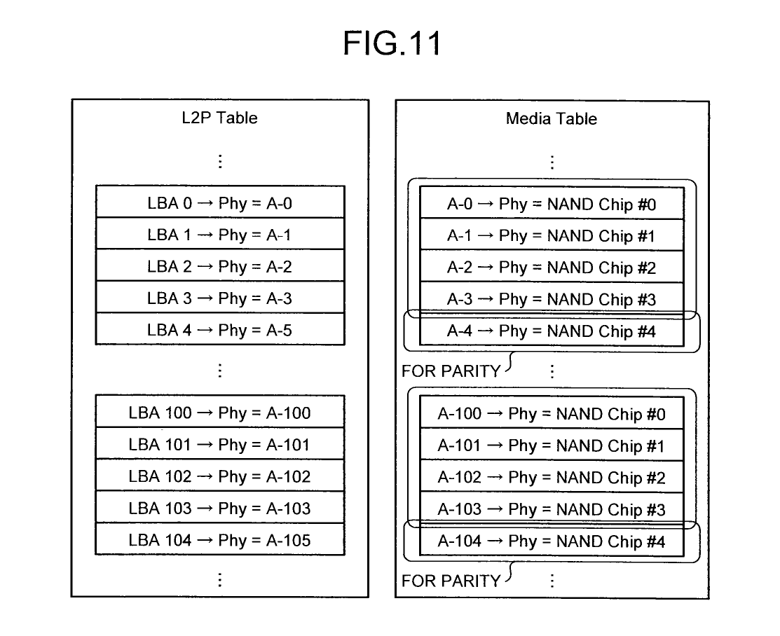

FIG. 11 is an example in which the physical address of the write destination of the parity is included in the media table. FIG. 11 is an example in which pieces of user data having first physical addresses of “A-0” to “A-3” are used to perform encoding, thereby generating a parity, and the first physical address of the parity is designated as “A-4” and written in a chip #4. On the L2P table, there is no entry corresponding to the first physical address of “A-4”, and the first physical address corresponding to LBA “3” is “A-3”. However, a first physical address corresponding to LBA “4” that is continuous to the LBA “3” becomes “A-5”. On the other hand, there is an entry of the first physical address of “A-4” corresponding to the parity in the media table. By having such a table configuration, a storage position of the parity can be ascertained by using the media table in the internal process of the storage device 1.

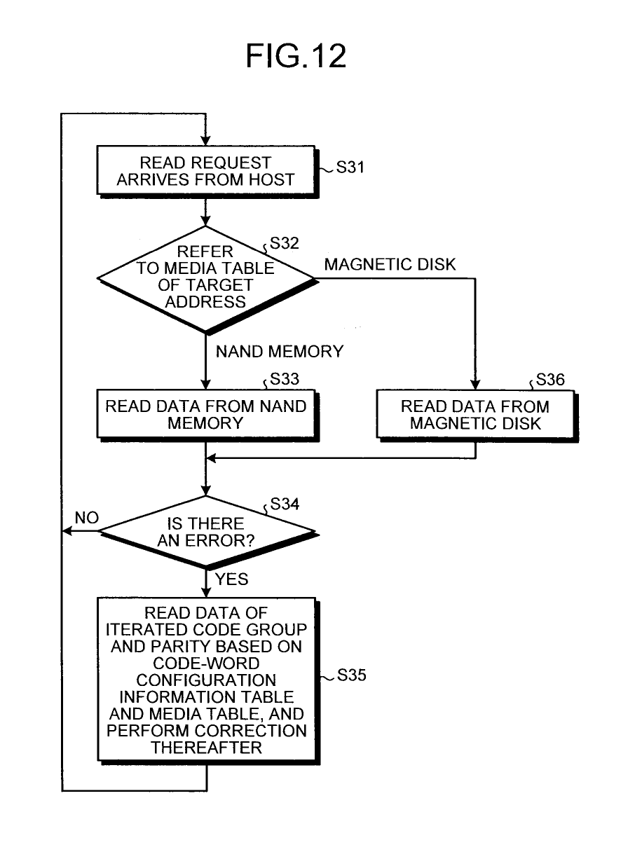

A process at the time of reading when the inter-page parity is used is explained next. FIG. 12 is an example of a reading process when the inter-page parity is used. In FIG. 12, when the in-page parity and one type of the inter-page parity are used, reading can be performed according to the reading process in FIG. 12. In the following descriptions, a code using the in-page parity and one type of the inter-page parity is referred to as “iterated code”.

First, Steps S31, S32, S33, and S36 are performed as the Steps S11, S12, S13, and S14 in FIG. 7. At Step S33, the error correction process using the in-page parity is performed as explained with reference to FIG. 7. Also at Step S36, when data to be written in the magnetic disk 4 has been encoded, the decoder 243 performs the error correction process. At Step S36, the decoder 233 performs the error correction process by using the user data and parity read from the magnetic disk 4 (or the user data error-corrected by the decoder 243 and the parity). The decoder 233 notifies the management unit 22 of whether error correction has been performed by the error correction process (whether there is no error).

After Step S33 or Step S36, the management unit 22 determines whether there is an error based on the notification from the decoder 233 (Step S34). When there is no error (No at Step S34), the process returns to Step S31. When there is an error (Yes at Step S34), the management unit 22 reads the user data and parity constituting a group of the iterated codes to which the user data to be read belongs, based on the code-word configuration table and the media table, to perform the error correction process (Step S35), and the process returns to Step S31.

At Step S35, the management unit 22 refers to the code-word configuration table based on a first physical address corresponding to the logical address of the user data to be read, and extracts the first physical address of the user data in the same group as the user data to be read. The management unit 22 obtains a second physical address corresponding to the extracted first physical address by referring to the media table, and instructs any one or both of the NAND control unit 23 and the disk control unit 24 to read data based on the second physical address. When all the pieces of user data and parities constituting the iterated code group are on the NAND memory 3, the NAND control unit 23 reads the pieces of user data and parities based on the second physical address instructed by the management unit 22, to perform the error correction process by using the in-page parity. When all the pieces of user data and parities constituting the iterated code group are on the magnetic disk 4, the disk control unit 24 reads data (a code word when the data is encoded by the encoder 242) based on the second physical address instructed by the management unit 22, and transmits the read data to the NAND control unit 23. The NAND control unit 23 performs error correction by using the in-page parity received from the disk control unit 24, and then performs the error correction process by using the pieces of user data and parities constituting the iterated code.

When the pieces of user data and parities constituting the iterated code group are stored both in the NAND memory 3 and the magnetic disk 4, the disk control unit 24 reads the data (a code word when the data is encoded by the encoder 242) based on the second physical address instructed by the management unit 22, and transmits the read data to the NAND control unit 23. The NAND control unit 23 performs error correction by using the in-page parity received from the disk control unit 24, and reads the pieces of user data and parities based on the second physical address instructed by the management unit 22 to perform error correction using the in-page parity. Thereafter, the NAND control unit 23 performs the error correction process by using the pieces of user data and parities constituting the iterated code.

In the present embodiment, an example in which all the pieces of user data are once stored in the NAND memory 3 has been explained. However, user data to be written initially in the magnetic disk 4 can be present. In this case, a second physical address of the user data to be written initially in the magnetic disk 4 becomes a physical address on the magnetic disk 4 from the start.

As described above, in the present embodiment, address conversion of the logical address and the physical address is performed by two-stage conversion, that is, conversion between the logical address and the first physical address, and conversion between the first physical address and the second physical address. The second physical address includes information for identifying the write destination medium, and when copying from the magnetic disk 4 to the NAND memory 3 is performed, the second physical address is updated to the information indicating the storage destination after the copying. Accordingly, when the inter-page parity is added to the user data to be stored in the NAND memory 3, even if the code word is stored in the magnetic disk 4 and the NAND memory 3 in a distributed manner, reading of the code word can be performed promptly.

### Second Embodiment

In the first embodiment, an example in which an iterated code is constituted by an in-page parity and one type of an inter-page parity has been explained. In a second embodiment, an example in which a plurality of types of inter-page parities is used to constitute an iterated code is explained. Configurations of the storage device 1 according to the present embodiment are identical to those of the first embodiment.

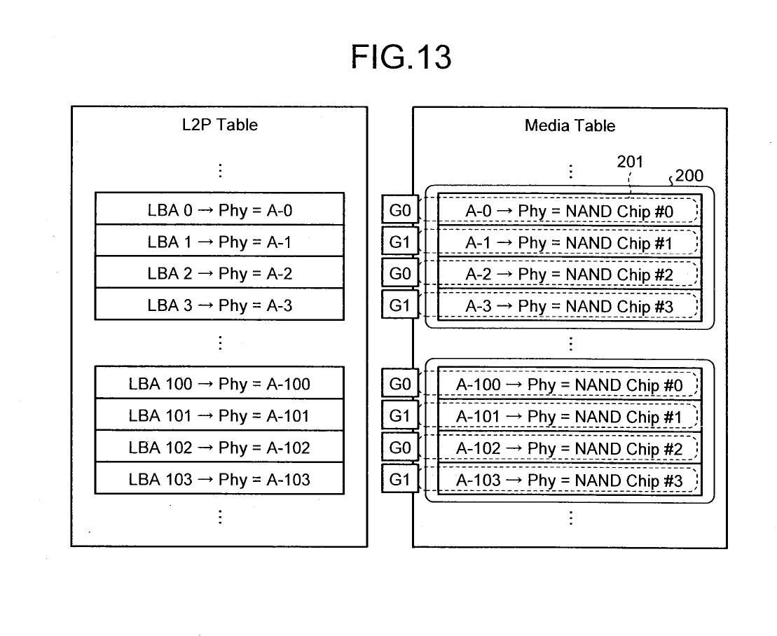

FIG. 13 is an example of a configuration of a code word according to the present embodiment. As shown in FIG. 13, user data having a first physical address enclosed as a code word group 200 is used to generate an inter-page parity. With this, user data having a first physical address of an entry described as a Group G0, of the entries enclosed by a dotted line as an entry 201, is used to constitute the inter-page parity, and user data having a first physical address of an entry described as a Group G1 is used to constitute the inter-page parity. Thus, by changing the constituting user data to generate a plurality of code words, and it is configured so that one user data belongs to a plurality of code words. For example, for the first entry, configuration information of these code words is stored in the code-word configuration table. The writing procedure of the present embodiment is identical to that of the first embodiment. However, in the write encoding process, a plurality of inter-page parities is generated.

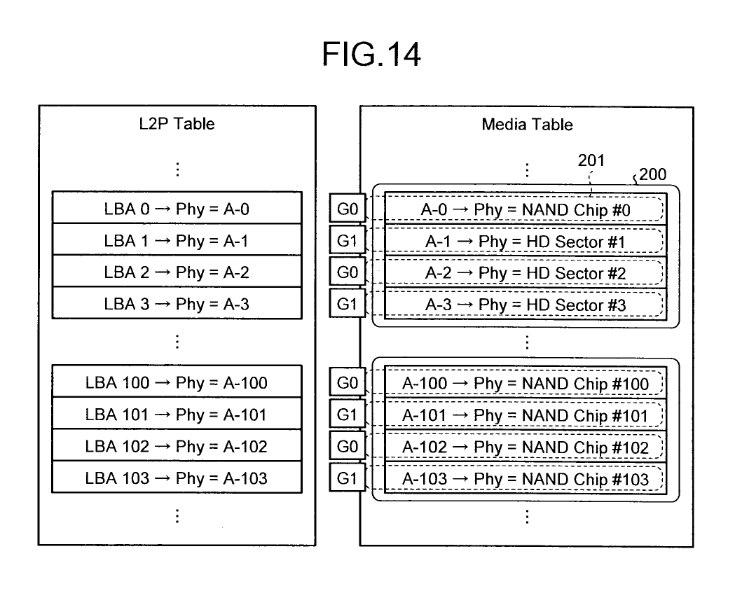

FIG. 14 is an example in which a part of user data is copied to the magnetic disk 4 from the state shown in FIG. 13. In FIG. 14, pieces of user data corresponding to the first physical addresses “A-1”, “A-2”, and “A-3” have been copied to the magnetic disk 4.

As described above, when the user data is protected by a plurality of inter-page parities, in the present embodiment, the inter-page parity to be used for error correction is selected based on the amount of user data and parities stored on the NAND memory 3, of the pieces of user data and parities constituting the code word. For the sake of simplicity, it is assumed here that the sizes of the code words in the group 200 and the group G0 are the same. In this case, for example, it is assumed that a read request of user data having the first physical address “A-0” is received. As in the first embodiment, the user data and a parity (an in-page parity) are read from the NAND memory 3, by using a second physical address corresponding to the first physical address “A-0”. It is assumed here that after the error correction process using the user data and the in-page parity has been performed, an error remains. In this case, as shown in FIG. 14, it is assumed that a part of user data in the group 200 is on the magnetic disk 4, and all the pieces of user data in the group G0 are on the NAND memory 3. The user data having the first physical address “A-0” belongs to both the group 200 and the group G0. In this case, reading of the code word in the group G0 is performed faster than reading of the code word in the group 200. Therefore, the inter-page parity corresponding to the group G0 can be selected as the inter-page parity to be used for error correction. Furthermore, when an error remains by the error correction process by using the group G0, the error correction process by using the group 200 can be performed.

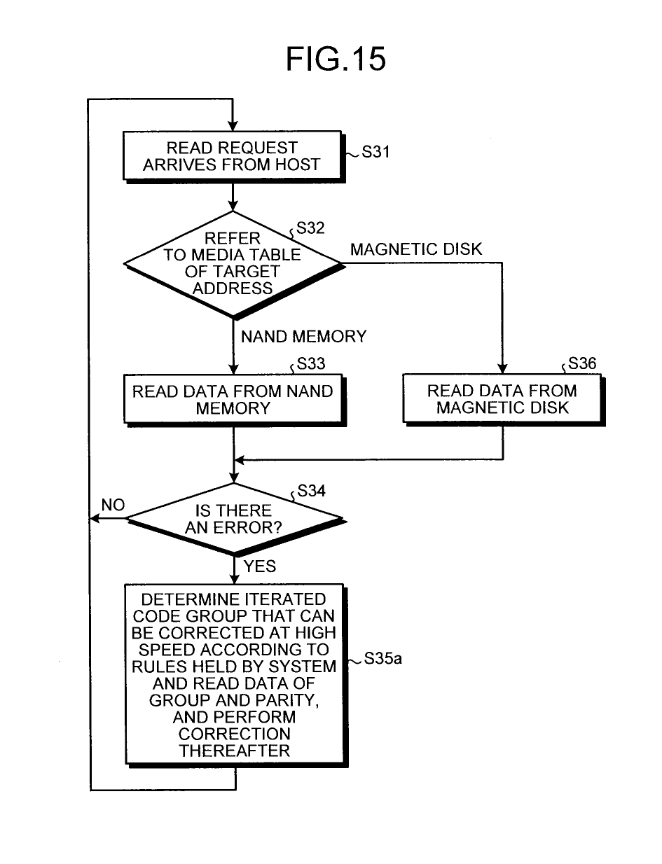

FIG. 15 is an example of a reading procedure when the user data is protected by a plurality of inter-page parities. Steps S31 to Steps S34 and S36 are the same as in the first embodiment. At Step S35a, an iterated code group that can be corrected at a high speed (the speed of reading and correction process becomes high) is determined, of the iterated code groups including the user data to be read, according to rules held by the system, and the user data and parity in the determined group are read, and the error correction process is performed. If the error cannot be corrected by the error correction process, an iterated code group that can be corrected at a secondary high speed is determined, the user data and parity in the determined group are read, and the error correction process is performed.

The rules held by the system are rules, for example, such that when a plurality of inter-page parities having the same size of the code word has been generated, the inter-page parity for which more pieces of user data and parities are stored on the NAND memory 3 is selected. The specific contents of the rules are not limited. When the size of the code word is different, the rules can be determined, taking the size of the code word into consideration, because comparison cannot be made simply based on only the amount of the user data and parity on the NAND memory 3.

As described above, in the present embodiment, when the user data is protected by the plurality of inter-page parities, the inter-page parity that can be corrected at a high speed is selected, a code word corresponding to the selected inter-page parity is read, and error correction is performed. Accordingly, the read speed at the time of performing error correction using the iterated code can be improved.

### Third Embodiment

A third embodiment is explained next. Configurations of the storage device 1 according to the present embodiment are identical to those of the first embodiment. A writing procedure and a reading procedure according to the present embodiment are identical to those of the first embodiment or the second embodiment.

After the user data and parity are stored in the NAND memory 3, a part of the user data constituting the code word may become invalid. The management unit 22 ascertains the logical address of the invalid user data. When copying of data from the NAND memory 3 to the magnetic disk 4 is performed, if a copy source area includes invalid user data, the management unit 22 performs copying to the magnetic disk 4 excluding the invalid user data by recalculating the parity. Specifically, the management unit 22 reads the entire code word including the invalid user data and performs the error correction process with respect to the entire code word. The management unit 22 then copies the user data, which is not invalid (which is valid), of the user data after the error correction process, to the magnetic disk 4.

The invalid user data is user data on a medium (the NAND memory 3 or the magnetic disk 4) in which correspondence information between the logical address and the first physical address is not present in the L2P table, and correspondence information between the first physical address and the second physical address is present in the media table.

When a code word including many pieces of valid user data is to be copied to the magnetic disk 4, copying can be collectively performed including the invalid user data, and the entry of the invalid user data can be deleted from the media table. Accordingly, the first physical address used for the invalid user data can be reused. Furthermore, the physical address on the magnetic disk 4 of the invalid user data copied to the magnetic disk 4 is recognized as a free area, because it is not present in the media table, and new user data can be overwritten.

As described above, in the present embodiment, the invalid user data is not copied to the magnetic disk 4, or the entry thereof is deleted from the media table. Accordingly, wasteful consumption of capacity by the invalid data can be prevented.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage device comprising:
an encoder that encodes user data to generate a parity;
a nonvolatile memory that stores the user data and the parity;
a magnetic disk; and
a management unit that determines a first physical address corresponding to a logical address of the user data, holds correspondence between the logical address and the first physical address as first conversion information, determines a second physical address indicating a storage destination of the user data corresponding to the first physical address, and holds correspondence between the first physical address and the second physical address as second conversion information, with the second physical address including media information indicating whether a medium of the storage destination is the nonvolatile memory or the magnetic disk and information indicating a storage position in the medium, wherein
when the user data stored in the nonvolatile memory is to be moved to the magnetic disk, the management unit controls so as to read the user data from the nonvolatile memory and write the read user data in the magnetic disk, and updates the second physical address corresponding to the first physical address corresponding to the user data in the second conversion information, to a value indicating a storage destination after the movement.

2. The storage device according to claim 1, wherein when user data to be written is newly received in a state where the nonvolatile memory does not have a free space, the management unit selects the user data to be moved to the magnetic disk based on an access frequency of the user data stored in the nonvolatile memory, and moves the selected user data to the magnetic disk.

3. The storage device according to claim 1, wherein when a logical address to be read is specified, the management unit acquires a first physical address corresponding to the logical address to be read based on the first conversion information, obtains a second physical address corresponding to the acquired first physical address based on the second conversion information, and controls to read the user data from the nonvolatile memory or the magnetic disk based on the obtained second physical address.

4. The storage device according to claim 1, further comprising a decoder that performs an error correction process by using the user data and the parity, wherein
the management unit holds a first physical address corresponding to the user data used for generating the parity by the encoder as code-word configuration information for each of the parities, acquires the first physical address of the user data used for generating the parity based on the code-word configuration information at a time of reading the user data, obtains a second physical address corresponding to the acquired first physical address based on the second conversion information, controls to read the user data used for generating the parity from the nonvolatile memory or the magnetic disk based on the obtained second physical address, and controls to input the read user data and the parity to the decoder.

5. The storage device according to claim 4, wherein
the encoder generates a first parity based on the user data to be written in one page of the nonvolatile memory, and generates a second parity based on the user data to be written in a plurality of pages of the nonvolatile memory, and
the management unit holds a first physical address corresponding to the user data used for generating the second parity as the code-word configuration information for each of the second parities, controls to write the first parity in a page where the user data used for generating the first parity is to be stored, and when a logical address to be read is specified, the management unit acquires a first physical address corresponding to the logical address to be read based on the first conversion information, obtains a second physical address corresponding to the acquired first physical address based on the second conversion information, controls to read the user data and the first parity from the nonvolatile memory or the magnetic disk based on the obtained second physical address, and controls to input the read user data and the first parity to the decoder, and when there is an error after an error correction process using the first parity performed by the decoder, the management unit acquires the first physical address of the user data used for generating the second parity, obtains a second physical address corresponding to the acquired first physical address based on the second conversion information, controls to read the user data from the nonvolatile memory or the magnetic disk based on the obtained second physical address, and controls to input the read user data and the second parity to the decoder.

6. The storage device according to claim 5, wherein the second parity is generated by using the user data to be stored in a plurality of blocks of the nonvolatile memory.

7. The storage device according to claim 5, wherein the second parity is generated by using the user data to be stored in a plurality of chips of the nonvolatile memory.

8. The storage device according to claim 5, wherein
the encoder generates a third parity based on the user data to be written in a plurality of pages of the nonvolatile memory, and the user data is used for generating both the second parity and the third parity, and
when there is an error after the error correction process using the first parity performed by the decoder, the management unit selects any one of the second parity and the third parity as a parity to be used for the error correction process, based on an amount of the user data stored in the nonvolatile memory of the user data used for generating the second parity, and an amount of the user data stored in the nonvolatile memory of the user data used for generating the third parity.

9. The storage device according to claim 1, further comprising a decoder that performs an error correction process by using the user data and the parity, wherein
when the user data stored in the nonvolatile memory is to be moved to the magnetic disk, if invalid data is included in the user data to be moved, the management unit controls to perform the error correction process by using the parity corresponding to the invalid data, and moves the user data to be moved after the error correction process, excluding the invalid data, to the magnetic disk.

10. The storage device according to claim 1, wherein when the user data stored in the nonvolatile memory is to be moved to the magnetic disk, if invalid data is included in the user data to be moved, the management unit deletes an entry corresponding to the invalid data in the second conversion information, after the user data to be moved including the invalid data is moved to the magnetic disk.

11. A memory controller that controls a nonvolatile memory and a magnetic disk, comprising:
an encoder that encodes user data to generate a parity;
a memory interface that writes the user data and the parity in the nonvolatile memory;
a disk interface that writes the user data read from the nonvolatile memory in the magnetic disk; and
a management unit that determines a first physical address corresponding to a logical address of the user data, holds correspondence between the logical address and the first physical address as first conversion information, determines a second physical address indicating a storage destination of the user data corresponding to the first physical address, and holds correspondence between the first physical address and the second physical address as second conversion information, with the second physical address including media information indicating whether a medium of the storage destination is the nonvolatile memory or the magnetic disk and information indicating a storage position in the medium, wherein
when the user data stored in the nonvolatile memory is to be moved to the magnetic disk, the management unit controls the memory interface and the disk interface to read the user data from the nonvolatile memory and write the read user data in the magnetic disk, and updates the second physical address corresponding to the first physical address corresponding to the user data in the second conversion information, to a value indicating a storage destination after the movement.

12. A memory control method in a storage device including a nonvolatile memory and a magnetic disk, wherein
user data is encoded and a parity is generated,
the user data and the parity are stored in the nonvolatile memory,
a first physical address corresponding to a logical address of the user data is determined, correspondence between the logical address and the first physical address is held as first conversion information, a second physical address indicating a storage destination of the user data corresponding to the first physical address, is determined, and correspondence between the first physical address and the second physical address is held as second conversion information, with the second physical address including media information indicating whether a medium as the storage destination is the nonvolatile memory or the magnetic disk and information indicating a storage position in the medium, and
when the user data stored in the nonvolatile memory is to be moved to the magnetic disk, it is controlled such that the user data is read from the nonvolatile memory and the read user data is written in the magnetic disk, and the second physical address corresponding to the first physical address corresponding to the user data in the second conversion information, is updated to a value indicating a storage destination after the movement.
